(19) United States
(12) Patent Application Publication
(10) Pub. No.: US 2021/0033413 A1
(43) Pub. Date: Feb. 4, 2021

(54) METHOD FOR PROVIDING ROUTE INFORMATION AND APPARATUS THEREFOR

(71) Applicant: Samsung Electronics Co., Ltd., Gyeonggi-do (KR)

(72) Inventors: Soojeong BAE, Gyeonggi-do (KR); Gilyong PARK, Gyeonggi-do (KR); Hongjin BAK, Gyeonggi-do (KR); Jiyoung LEE, Gyeonggi-do (KR); Taiwook JWA, Gyeonggi-do (KR)

(73) Assignee: Samsung Electronics Co., Ltd., Gyeonggi-do (KR)

(21) Appl. No.: 16/966,633

(22) PCT Filed: Jan. 31, 2019
(86) PCT No.: PCT/KR2019/001321

§ 371 Date: Jul. 31, 2020

(30) Foreign Application Priority Data
Feb. 2, 2018 (KR) 10-2018-0013431

(51) Int. Cl. G01C 21/34; G01C 21/36

(52) U.S. Cl. CPC G01C 21/3461; G01C 21/3691; G01C 21/3484

(57) ABSTRACT

The disclosure relates to a method and apparatus for providing route information, The method of providing the route information, the method being performed by a base station, according to an embodiment of the disclosure, may include obtaining information about a route between a location of a user and a destination requested by the user, receiving metadata representing at least one of a geographical feature and an object within a preset coverage from a connectivity node, determining a final route to the destination based on the obtained information about the route and the received metadata, and transmitting information about the determined final route to a terminal of the user.

### TECHNICAL FIELD

The disclosure relates to a method of providing route information and an apparatus for providing the route information.

### BACKGROUND ART

Recently, there have been worldwide efforts to build urban environments where safer and more convenient lives can be enjoyed using information and communication technologies. Among various current challenges in this regard, many local and central government organizations make public safety, transportation, digital equity, etc., their top priorities.

For example, the local and central government organizations are trying to apply image data obtained by, e.g., CCTVs and data obtained by IoT sensors to various areas, such as for public safety improvement and solution of traffic problems. The local and central government organizations have installed wired cameras to obtain image data, but due to the costs of cable construction, there is a growing need to use wireless technologies to obtain data. However, when existing communication systems are used, a lot of radio resources are required because a vast amount of data needs to be transmitted to a base station from an electronic device such as a CCTV, IoT sensor, etc., but it is difficult to guarantee the quality.

Hence, research on providing useful information for a terminal of a user using data sensed by the electronic device such as, e.g., CCTV, is still required.

### DESCRIPTION OF EMBODIMENTS

### Technical Problem

The disclosure provides a method and apparatus for providing route information, for a base station to use metadata about at least one of a geographical feature and an object generated by a connectivity node to provide route information to a terminal of a user taking into account environments around the user.

### Solution to Problem

The disclosure relates to a method and apparatus for providing route information. A method of providing route information by a base station, according to an embodiment of the disclosure may include obtaining information about a route between a location of a user and a destination requested from the user, receiving metadata representing at least one of a geographical feature and an object within preset coverage from a connectivity node, determining a final route to the destination based on the obtained information about the route and the received metadata, and transmitting information about the determined final route to a terminal of the user.

### Advantageous Effects of Disclosure

According to embodiments of the disclosure, a base station may provide route information taking into account a geographical feature and an object by providing metadata that represents at least one of the geographical feature and the object through a connectivity node.

Furthermore, the connectivity node may generate metadata by analyzing sensed data about the geographical feature and the object and may provide the metadata to the base station, thereby effectively reducing an amount of data to be transmitted to the base station and an amount of computation of data to be processed by the base station.

### BRIEF DESCRIPTION OF THE DRAWINGS

FIG. 1 is a conceptual diagram for describing a system for providing route information, according to an embodiment.

FIG. 2 is a flowchart for describing a method in which a base station provides route information, according to an embodiment.

FIG. 3 is a flowchart for describing a method in which a connectivity node provides route information, according to an embodiment.

FIG. 4 is a diagram for describing a method in which a base station provides a warning indicating to a user terminal that there is a danger, according to an embodiment.

FIG. 5 is a diagram for describing a method in which a connectivity node provides a warning indicating to a user terminal that there is a danger, according to an embodiment.

FIG. 6 is a diagram for describing a method in which a base station determines a final route based on metadata received from a connectivity node, according to an embodiment.

FIG. 7 is a diagram for describing a method in which a base station provides route information for a terminal of a user, according to another embodiment.

FIG. 8 is a diagram for describing a method in which a base station provides a terminal of a user with guide information in a notification to avoid a dangerous situation, according to an embodiment.

FIG. 9 is a block diagram of a base station, according to an embodiment.

FIG. 10 is a block diagram of a connectivity node, according to an embodiment.

### BEST MODE

According to an embodiment of the disclosure, a method of providing route information by a base station may include obtaining information about a route between a location of a user and a destination requested from the user, receiving metadata representing at least one of a geographical feature and an object within preset coverage from a connectivity node, determining a final route to the destination based on the obtained information about the route and the received metadata, and transmitting information about the determined final route to a terminal of the user.

The determining of the final route may include comparing the received metadata with a database preset for avoidance targets to determine a point with the avoidance target or a point predicted to have the avoidance target in the route; and setting a weight for the determined point in the route to be relatively lower than weights for other points between the location of the user and the destination to revise the route between the location of the user and the destination.

The method may further include obtaining user information including at least one of information about route characteristics preferred by the user and information about a condition of the user, and the determining of the final route may include setting a weight for at least one route between the location of the user and the destination based on the user information so as to determine the final route.

The obtaining of the user information may include obtaining the user information based on information about at least one route selected by the user before determining the final route, by using a pre-generated learning network model.

The metadata may be periodically received from the connectivity node at preset time intervals, and the method of providing route information may further include predicting a dangerous situation likely to occur to the user based on the periodically received metadata and a location of the user at a time of receiving the metadata; and transmitting a notification about the predicted dangerous situation to the terminal of the user.

The method may further include generate guide information to avoid the predicted dangerous situation based on time required for the terminal of the user to receive a notification about the dangerous situation, moving speed of the user, and a time at which the dangerous situation is predicted to occur, and the notification may include the generated guide information.

According to an embodiment of the disclosure, a, method of providing route information by a connectivity node may include receiving data about a geographical feature and an object within preset coverage sensed from at least one electronic device; generating, by analyzing the received data, metadata representing at least one of the geographical feature and the object; and transmitting the generated metadata to a base station.

The generating of the metadata may include analyzing at least one of type, mobility, and density of the object, and inclination of the geographical feature, based on the received data.

The method may further include obtaining location information of a user; and predicting a dangerous situation likely to occur to the user based on the received data when it is determined based on the location information of the user that the user is located within the preset coverage; and transmitting a notification about the predicted dangerous situation to a terminal of the user.

The method may further include generating guide information to avoid the predicted dangerous situation based on time required for the terminal of the user to receive a notification about the dangerous situation, moving speed of the user, and a time at which the dangerous situation is predicted to occur, and the notification may include the generated guide information.

According to an embodiment of the disclosure, a base station may include a transceiver configured to obtain information about a route between a location of a user and a destination requested from the user, and receive metadata representing at least one of a geographical feature and an object within preset coverage from a connectivity node; at least one processor configured to determine a final route to the destination based on the obtained information about the route and the received metadata; and a memory storing information about the final route, wherein the transceiver is further configured to transmit the information about the determined final route to a terminal of a user.

According to an embodiment of the disclosure, a connectivity node may include a transceiver configured to receive data about a geographical feature and an object within preset coverage sensed from at least one electronic device; at least one processor configured to generate, by analyzing the received data, metadata representing at least one of the geographical feature and the object; and a memory storing the generated metadata, wherein the transceiver is further configured to transmit the generated metadata to a base station.

### MODE OF DISCLOSURE

Terms as used herein will be described before detailed description of embodiments of the disclosure.

The terms are selected as common terms widely used now, taking into account principles of the disclosure, which may however depend on intentions of ordinary people in the art, judicial precedents, emergence of new technologies, and the like. Some terms as herein used are selected at the applicant's discretion, in which case, description thereof will be explained later in detail. Therefore, the terms should be defined based on their meanings and descriptions throughout the disclosure.

It will be understood that, although the terms first, second, third, etc., may be used herein to describe various components, these components should not be limited by these terms. These terms are only used to distinguish one element, component, region, layer or section from another region, layer or section. Thus, a first element, component, region, layer or chamber discussed below could be termed a second element, component, region, layer or section without departing from the teachings of the disclosure, Descriptions shall be understood as to include any and all combinations of one or more of the associated items when the items are described by using the conjunctive term “˜ and/or ˜,” or the like.

The term “include (or including)” or “comprise (or comprising)” is inclusive or open-ended and does not exclude additional, unrecited elements or method steps. The term “module” (or sometimes “unit”) as used herein refers to a software or hardware component, such as field programmable gate array (FPGA) or application specific integrated circuit (ASIC), which performs some functions. However, the unit is not limited to software or hardware. The module may be configured to be stored in an addressable storage medium, or to execute one or more processors. For example, the unit may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and units may be combined into a less number of components and units, or further divided into a more number of components and units.

Embodiments of the present disclosure will now be described in detail with reference to accompanying drawings to be readily practiced by an ordinary skill in the art. However, the embodiments of the disclosure may be implemented in many different forms, and not limited thereto as will be discussed herein. In the drawings, parts unrelated to the description of the disclosure are omitted for clarity, and like numerals refer to like elements throughout the specification.

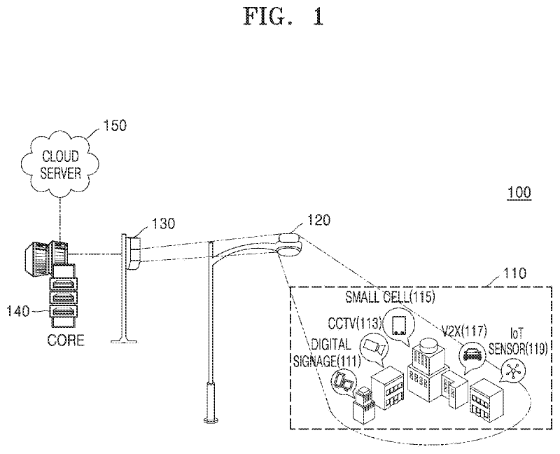

FIG. 1 is a conceptual diagram for describing a system 100 for providing route information, according to an embodiment.

Referring to FIG. 1, the system 100 for providing route information may include at least one electronic device 110, a connectivity node 120, a base station 130, a core 140, and a cloud server 150. Elements of the system 100 for providing route information according to an embodiment are not, however, limited thereto. In another embodiment, the system 100 for providing route information may include more or fewer elements than mentioned above. For example, the route information providing system 100 may include at least one electronic device, a connectivity node, and a base station.

The at least one electronic device 110 may sense at least one of an object and a geographical feature within preset coverage. In this specification, the object may include human and things such as bicycles, automobiles, buildings, etc. When an object is stationary, the at least one electronic device 100 may sense the position, shape, and size of the stationary object, and when an object is mobile, it may sense moving speed, moving direction, real-time location, shape, and size of the object. It is, however, merely an example, and the object sensed by the at least one electronic device 110 is not limited to the aforementioned example.

Furthermore, the at least one electronic device 110 may be one of devices including a digital signage 111, a CCTV 113, a small cell 115, a vehicle to everything (V2X) 117, and an Internet of Things (IoT) sensor 119, without being limited thereto.

The connectivity node 120 may receive data about a geographical feature and an object within preset coverage from the at least one electronic device 110. For example, the connectivity node 120 may periodically receive the data from the at least one electronic device 110 at preset time intervals. Furthermore, in another example, when new data about a geographical feature or an object is sensed by the at least one electronic device 110, the connectivity node 120 may receive the sensed data.

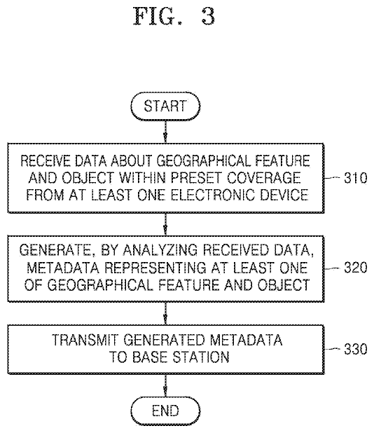

The connectivity node 120 may analyze the received data to generate metadata that represents a geographical feature and an object within preset coverage. How the connectivity node 120 analyzes the data received will be described in detail later with reference to FIG. 3,

In the meantime, the connectivity node 120 may transmit the generated metadata to the base station 130. The connectivity node 120 may efficiently reduce an amount of data to be transmitted to the base station 130 by transmitting the metadata to the baste station 130 instead of the sensed data itself. Accordingly, an amount of calculation on data to be processed by the base station 130 may be reduced as well.

The base station 130 may determine a location of the user based on location information obtained from a terminal (not shown) of the user, Furthermore, the base station 130 may receive information about a destination from the terminal of the user when the user enters a particular destination to which the user wants to go to the terminal of the user. The base station 130 may first obtain information about a basic route between the location of the user and the destination to provide route information for the user. The basic route represents a route for which any geographic features and objects between the location of the user and the destination are not taken into account For example, the basic route may be set to a shortest distance. The base station 130 may obtain information about the basic route from navigation information stored in advance, or obtain information about the basic route from an external navigation device or navigation system.

In the meantime, according to an embodiment, the base station 130 may receive from at least one connectivity node (e.g., 120) metadata that represents geographical features and objects within coverage set for each connectivity node. The base station 130 may determine whether there is an avoidance target among points located in the aforementioned basic route based on the metadata received from the at least one connectivity node (e.g., 120). The avoidance target may include a point with a high population density, a construction site, a point at which a traffic accident has occurred, and a point where there is a staircase, which may be changed according to settings.

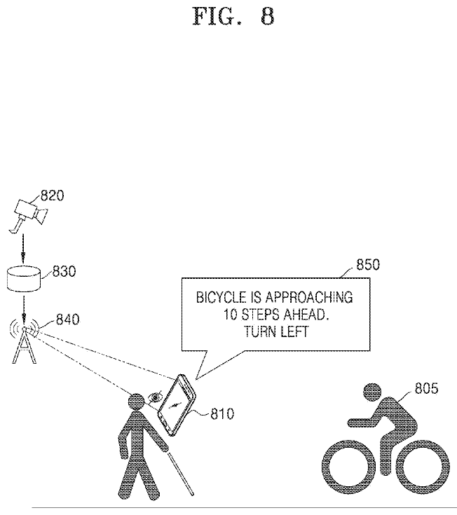

The base station 130 may change at least part of the basic route to another route by setting a low weight on the point where there is the avoidance target in the basic route. The base station 130 may transmit information about a final route obtained from the result of change to the terminal of the user. Furthermore, the base station 130 may receive metadata about a geographical feature and an object from at least one connectivity node (e.g., 120) in real time, and thus predict a dangerous situation that might occur to the user. The base station 130 may transmit a notification including information about the predicted dangerous situation and guide information to avoid the dangerous situation to the terminal of the user. This will be described in more detail with reference to FIG. 8. It is, however, merely an example, and the connectivity node 120 may transmit the notification directly to the terminal of the user to provide the notification more quickly to the terminal of the user.

The core 140 may collect and store the metadata received by at least one base station (e.g., 130) from the connectivity node (e.g., 120). Furthermore, according to another embodiment, the core 140 may perform the aforementioned operations of the base station 130.

The cloud server 150 may store the metadata collected by the core 140. Furthermore, the cloud server 150 may provide at least part of the metadata previously collected to the core 140 at a request from the core 140.

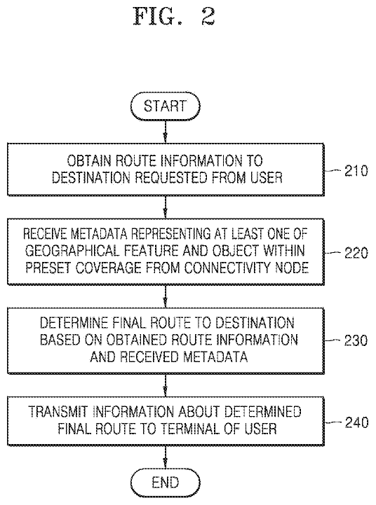

Referring to FIGS. 2 to 10, how the base station 130 and the connectivity node 120 provide route information will now be described in more detail.

FIG. 2 is a flowchart for describing a method in which a base station provides route information, according to an embodiment.

In operation 210, the base station may obtain information about a route between a location of a user and a destination requested from the user.

For example, the base station may receive information about a location of the user from the terminal of the user. Furthermore, the base station may receive information about a destination entered by the user to the terminal from the terminal of the user.

According to an embodiment, the base station may obtain information about the basic route to go through from the location of the user to the destination based on the information about the location of the user and the destination. For example, the base station may obtain information about a shortest distance to go through from a point A, the location of the user, to a point B, the destination as the information about the basic route.

In operation 220, the base station may receive metadata that represents at least one of a geographical feature and an object within preset coverage from the connectivity node.

According to an embodiment, as the base station obtains information about the location of the user and the destination, the base station may receive metadata from at least one connectivity node with coverage including points between the location of the user and the destination. Each of the at least one connectivity node may receive sensed data from an electronic device that performs sensing on at least one of an object and a geographic feature within the coverage.

Even when the electronic device that performs sensing is not equipped with a cellular communication function, the base station may obtain information about the geographical feature and the object by obtaining the metadata through the connectivity node. The electronic device and the connectivity node may transmit or receive the sensed data through at least one of Ethernet, Wi-Fi, Zigbee, BLE, and Bluetooth, which is, however, merely an example, and a communication method between the electronic device and the connectivity node is not limited to the aforementioned example.

In operation 230, the base station may determine a final route to the destination based on the obtained information about the route and the received metadata.

According to an embodiment, the base station may revise the route between the location of the user and the destination based on the received metadata. For example, the base station may compare a database preset for avoidance targets with the received metadata to revise the route between the location of the user and the destination. Information about weights depending on objects or geographic features may be stored in the database preset for the avoidance target. For example, the information about weights depending on objects or geographic features, such as −3 for an inclined point, −5 for construction being under way, −2 for a point with high population density, etc., may be stored.

The base station may compare the received metadata with the database preset for the avoidance target to determine a point with an avoidance target or a point predicted to have the avoidance target in the route. Furthermore, the base station may set a weight for the determined point in the route to be lower than weights for other points between the location of the user and the destination to revise the route between the location of the user and the destination.

In the meantime, according to an embodiment, the base station may obtain user information including at least one of information about route characteristics preferred by the user and information about a condition of the user. For example, the information about route characteristics preferred by the user may include a point with inclination of X degrees or less and a point with a Y or less population density. Furthermore, the information about a condition of the user may include sex, age, stride, proficiency in driving, whether the user has disability, or the like. The aforementioned example, however, is merely an example of the information about the route characteristics preferred by the user and the condition information of the user, and may further include other information.

In another example, the base station may obtain the user information based on information about at least one route selected by the user before determining the final route, by using a pre-generated learning network model. The learning network model may be obtained as a result of training a neural network based on the information about a route previously selected by the user to obtain route characteristics preferred by the user or the user condition information.

The base station may set up a route with the highest weight as the final route by setting weights for at least one route between the user location and the destination based on the user information. Furthermore, a weight for the aforementioned avoidance target may also be determined based on the user information. For example, the base station gives a weight, −5, to a staircase for the age equal to 60 or more, and a weight, −3, to the staircase for the age younger than 60.

In operation 240, the base station may transmit information about the determined final route to a terminal of the user.

The user may check a route from the current location to the destination from the information about the final route transmitted by the base station.

Furthermore, according to an embodiment, the base station may periodically receive metadata at preset time intervals from the connectivity node. The base station may predict a dangerous situation that might occur to the user based on the periodically received metadata and a location of the user at the time when the metadata is received. The base station may transmit a notification about the predicted dangerous situation to the terminal of the user. This will be described in more detail with reference to FIG. 8.

FIG. 3 is a flowchart for describing a method in which a connectivity node provides route information, according to an embodiment.

In operation 310, a connectivity node may receive sensed data about a geographical feature and an object within preset coverage from the at least one electronic device 110.

In an embodiment, the data received by the connectivity node may include image information about a road, a building, a sign post, a vehicle, a person, etc., information about a signal and waiting time of a signal lamp, whether a street lamp is flickering, brightness of the street lamp, etc., which is merely an example, but the data received by the connectivity node is not limited thereto.

In operation 320, the connectivity node may generate, by analyzing the received data, metadata that represents at least one of a geographical feature and an object.

For example, the connectivity node may classify the received data by at least one of type, mobility and density of the object, and inclination of the geographical feature. The type of object may include a person, a vehicle, an animal, a building, etc. Furthermore, in a case of classifying the data by mobility, it may be classified into a stationary geographical feature, object and a mobile geographical feature, object. For example, roads, sidewalks, buildings, signal lamps, utility poles, crosswalks, sign posts, etc., may be classified as stationary geographical features or objects, and vehicles, people, animals, etc., may be classified as mobile geographical features or objects. Furthermore, the density may include a population density and a vehicle density, and the inclination of a geographical feature may include an uphill road and a downhill road determined based on whether the inclination is greater than a threshold.

The connectivity node may generate metadata that represents a geographical feature and an object within preset coverage based on the analysis result. For example, the metadata may include information about a type of object and geographical feature, an inclination angle, a speed and direction of a mobile object, etc.

In operation 330, the connectivity node may transmit the generated metadata to the base station.

According to an embodiment, the connectivity node may process a vast amount of data received from at least one electronic device and transmit metadata which is a result of obtaining from the process to a base station, thereby reducing an amount of data to be transmitted to the base station and further reducing an amount of calculation on data to be processed by the base station.

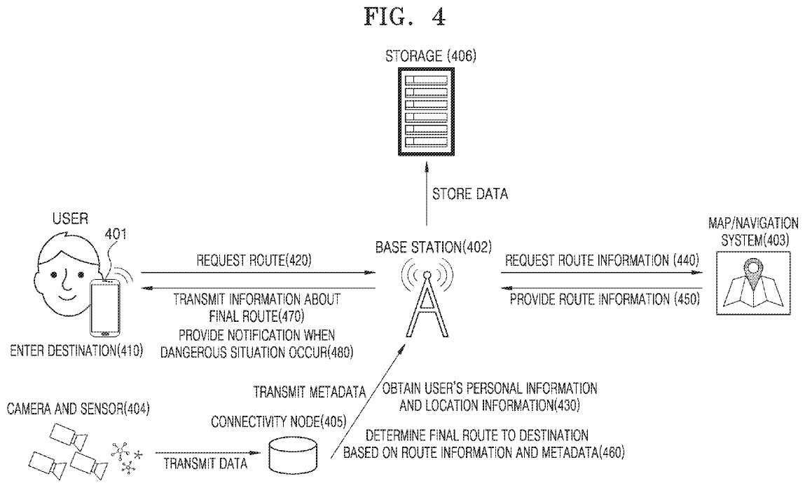

FIG. 4 is a diagram for describing a method in which a base station 402 provides a warning indicating to a terminal 401 of the user that there is a danger, according to an embodiment.

In operation 410, the user may enter information about a destination to the terminal 401 of the user.

In operation 420, as the destination is entered from the user, the terminal 401 of the user may request from the base station 402 a route to the destination.

In operation 430, the base station 402 may obtain user information and location information. The user information may include at least one of information about route characteristics preferred by the user and condition information of the user, as described above with reference to FIG. 2. Furthermore, the location information may include information about a location of the user at the time of requesting the destination. It is, however, merely an example, and in another embodiment, information about a current location of the user may be included in the request for a route transmitted to the base station 402.

In operation 440, the base station 402 may request information about a route from the location of the user to the destination from a map/navigation system 403.

In operation 450, the map/navigation system 403 may provide information about a route from the location of the user to the destination in response to the request from the base station 402.

In operation 460, the base station 402 may determine a final route to the destination based on the information about the route and the metadata.

The metadata may be transmitted to the base station 402 from a connectivity node 405. The metadata may be generated by the connectivity node 405 based on data about at least one of an object and a geographical feature within preset coverage sensed by an electronic device such as a camera and a sensor 404.

In an embodiment, the base station 402 may determine a point corresponding to an avoidance target in the route received from the map/navigation system 403 through the metadata. This may correspond to what is described above with reference to FIG. 2. The base station 402 may determine a final route by setting a low weight for the point corresponding to the avoidance target in the received route and revising the route.

In operation 470, the base station 402 may transmit information about the final route to the terminal 401 of the user.

Furthermore, the base station 402 may store the metadata received from the connectivity node 405 and the information about the determined final route in a storage 406.

In operation 480, when a dangerous situation occurs, the base station 402 may provide a warning about this.

In an embodiment, the base station 402 may receive from the connectivity node 405 metadata that represents a geographic feature and an object in real time. When the base station 402 predicts that a dangerous situation, such as an object approaching the user, might occur, based on the metadata received in real time, the base station 402 may transmit a notification including information about the prediction. Furthermore, the notification may include guide information to avoid the predicted dangerous situation.

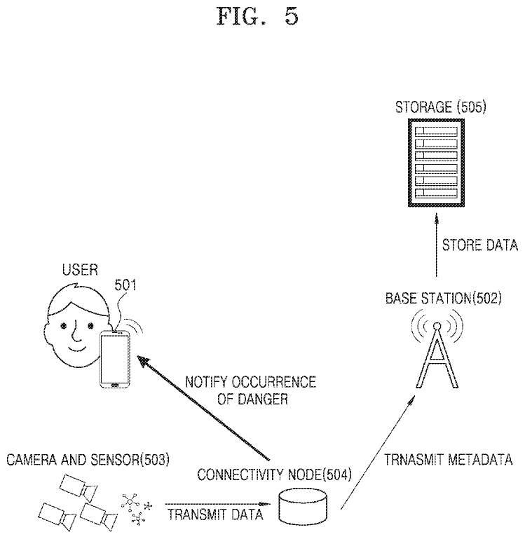

FIG. 5 is a diagram for describing a method in which a connectivity node 504 provides a warning indicating to a terminal 501 of the user that there is a danger, according to an embodiment.

Referring to FIG. 5, the connectivity node 504 may generate metadata that represents an object and a geographical feature based on data about at least one of an object and a geographical feature within preset coverage sensed by an electronic device such as a camera and a sensor 503. The connectivity node 504 may transmit the generated metadata to the base station 502. The base station 502 may store the metadata received from at least one connectivity node (e.g., 504).

In the meantime, the connectivity node 504 may predict whether a dangerous situation is likely to occur to the user based on the generated metadata and the location of the user when the user is located within coverage of the connectivity node 504. For example, the connectivity node 504 may determine a type of an object approaching the user and the approaching speed of the object based on the information about the location of the user. The information about the location of the user may be received from the terminal 501 of the user.

Furthermore, the connectivity node 504 may transmit information about a dangerous situation to the terminal 501 of the user when the dangerous situation is predicted to be likely to occur to the user due to the object approaching the user. Moreover, the connectivity node 504 may transmit guide information for the user to avoid the dangerous situation to the terminal 501 of the user. In this case, the guide information may be generated based on time required for the terminal 501 of the user to receive the notification, moving speed of the user, and a time at which a dangerous situation is predicted to occur. In other words, to more accurately predict a dangerous situation that might occur at reception time at the terminal 501 of the user, the connectivity node 504 may generate guide information to avoid the dangerous situation by taking into account the aforementioned factors.

In the embodiment, the connectivity node 504 may transmit a notification about a dangerous situation directly to the terminal 501 of the user to reduce latency when the user is located within the coverage and there is a danger.

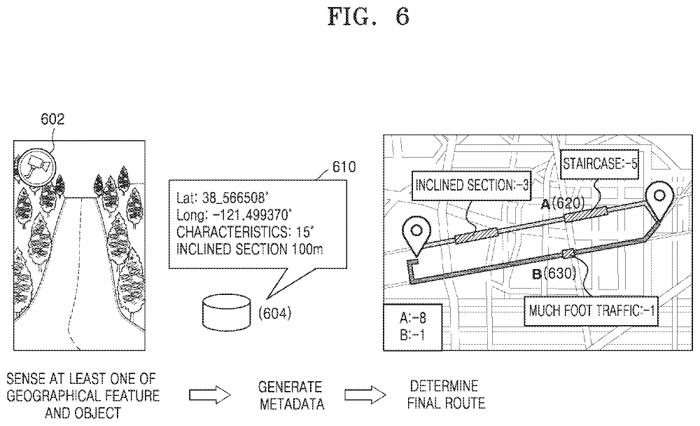

FIG. 6 is a diagram for describing a method in which a base station determines a final route based on metadata received from a connectivity node 604, according to an embodiment.

Referring to FIG. 6, a CCTV 602, one of electronic devices, may sense at least one of a geographical feature and an object around the CCTV 602. The CCTV 602 may transmit data obtained as a result of the sensing to the connectivity node 604.

The connectivity node 604 may generate metadata 610 that represents at least one of a geographical feature and an object based on the data received from the CCTV 602. For example, the metadata 610 may include information about latitude (lat) and longitude (long) and information about a degree of inclination and length of an inclined section. It is, however, merely an example of metadata about a geographical feature, and in another example, metadata about an object, such as a population density, presence of a staircase, etc., may be generated.

The connectivity node 604 may transmit the generated metadata to the base station. The base station may compare the received metadata with points between a location of the user and a destination to determine a final route. For example, the base station may determine that there are an inclined section and a staircase as avoidance targets as a result of determining each point locate in route A 620 based on the metadata. The base station may find weights −3 and −5 for the inclined section and the staircase, respectively, from a database preset for avoidance targets. In the meantime, the weight may be differently set for each user.

For example, as a result of determining the respective points located in route B 602 based on the metadata, the base station may determine that there is a point with much foot traffic preset as an avoidance target. The base station may find a weight being −1 for the point with much foot traffic from the database preset for avoidance targets.

The base station may obtain final weights −8 and −1 by combining weights for the route A 620 and the route B 630, respectively. The base station may determine a final route to be the route B 630 with the larger weight. It is, however, merely an example of a method in which the base station calculates a weight to determine a final route, and the method in which the base station calculates a weight for each route is not limited to the example.

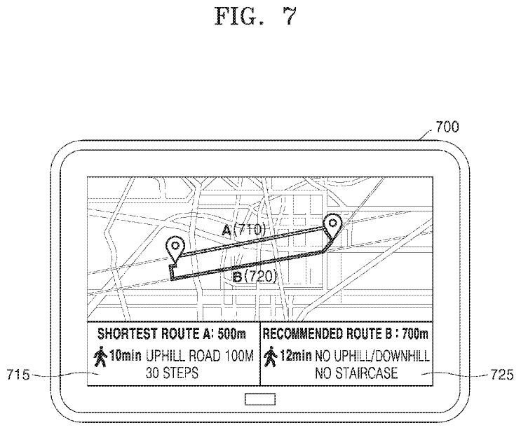

FIG. 7 is a diagram for describing a method in which a base station provides route information for a terminal 700 of a user, according to another embodiment.

Referring to FIG. 7, the base station may receive information about a location of the user and information about a destination requested by the user from the terminal 700 of the user. The base station may obtain route information to go to the destination from the location of the user based on the location of the user and the destination received from the terminal 700. In this case, the route information initially obtained by the base station is one for which geographical features and objects are not taken into account, and thus called a basic route to be distinguished from a final route in this specification. The basic route may be set up as a shortest route between the location of the user and the destination, which is represented as route A 710 in this embodiment.

In the meantime, the base station may receive metadata that represents at least one of a geographical feature and an object at points located between the location of the user and the destination from the connectivity node. The base station may determine whether there is an avoidance target or whether there is a point preferred by the user among the points located between the location of the user and the destination based on the metadata.

From the determination result, the base station may determine that there is an uphill road and a staircase that are set as avoidance targets in the basic route, the route A 710. The base station may then determine route B 720 as the final route by lowering the weight for the point set as the avoidance target and discovering another route.

The base station may transmit both information about the basic route and information about the final route to the terminal 700 of the user. The information about the basic route may be presented as shortest route information 715 to indicate that it corresponds to the shortest route, and the information about the final route may be presented as recommended route information 725 that takes into account geographical features and objects.

FIG. 8 is a diagram for describing a method in which a base station 840 provides a terminal 810 of a user with guide information in a notification to avoid a dangerous situation, according to an embodiment.

Referring to FIG. 8, a CCTV 820, an example of electronic device, may sense at least lone of a geographical feature and an object located within coverage of the CCTV 820. The CCTV 820 may transmit data obtained as a result of the sensing to a connectivity node 830.

The connectivity node 830 may generate metadata that represents at least one of a geographical feature and an object based on the received data. How the connectivity node 830 generates the metadata may correspond to the method as described above with reference to FIG. 3. The connectivity node 830 may transmit the generated metadata to the base station 840.

Upon reception of the metadata from the connectivity node 830, the base station 840 may determine whether there is a dangerous situation that is likely to occur in the location of the user. In this case, to determine whether there is a dangerous situation, the base station 840 may use the location of the user and user information. The user information may include at least one of information about route characteristics preferred by the user and condition information of the user. For example, in the embodiment shown in FIG. 8, it is assumed that the user is a blind person.

The base station 840 may determine whether there is an object approaching the user at location B of the user based on the metadata by considering that the user hardly recognizes any object around him/her. For example, the base station 840 may determine that a bicycle is approaching the user based on the metadata.

The base station 840 may provide the user with information about a dangerous situation and guide information to avoid the dangerous situation in a notification 850. For example, the notification 850 may include information about a dangerous situation, such as a direction in which the bicycle is approaching, a distance between the bicycle and the user, etc., and guide information to turn left.

Furthermore, to provide the guide information intuitively for the user, the base station may provide the guide information based on steps or time left apart from a standard unit such as meters, feet, miles, etc.

In the meantime, the guide information may be generated based on time required for the terminal of the user to receive the information, moving speed of the user, and a time at which a dangerous situation is predicted to occur.

The terminal 810 of the user may output the notification 850 received from the base station 840 in the form of sound data. Accordingly, the user may avoid the dangerous situation through the notification 850.

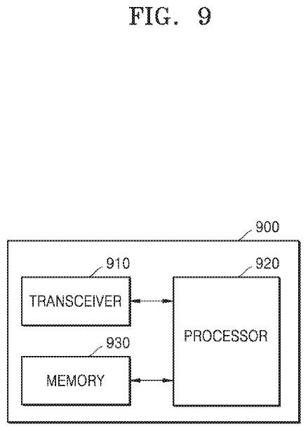

FIG. 9 is a control block diagram of a base station 900, according to an embodiment of the present disclosure.

Referring to FIG. 9, the base station 900 may include a transceiver 910, a processor 920, and a memory 930. According to the method of providing route information by the base station 900 as proposed in the above embodiments of the disclosure, the transceiver 910, the processor 920, and the memory 930 may operate. The elements of the base station 900 are not, however, limited thereto. For example, the base station 900 may include more or fewer elements than described above. In addition, in a particular occasion, the transceiver 910, processor 920, and memory 930 may be implemented in a single chip.

The transceiver 910 may transmit or receive signals to or from a terminal or a connectivity node. In this case, the signal may include metadata, route information, notification about a dangerous situation, etc., but it is merely an example and is not limited to the aforementioned example. For example, the transceiver 910 may obtain information about a route between a location of a user and a destination requested from the user. The transceiver 910 may receive metadata that represents at least one of a geographical feature and an object within preset coverage from the connectivity node.

In addition, the transceiver 910 may receive a signal on a wireless channel and output the signal to the processor 920, and transmit a signal output from the processor 920 on a wireless channel.

The processor 920 may control a series of processes for the base station 900 to operate in accordance with the embodiments of the present disclosure. For example, the processor 920 may perform a method of providing route information in the aforementioned embodiments of the disclosure.

In an embodiment, the processor 920 may determine a final route to the destination based on the obtained information about the route and the received metadata through the transceiver 910. The processor 920 may compare the received metadata with a database preset for avoidance targets to determine a point with an avoidance target or a point predicted to have the avoidance target in the route. The processor 920 may set a weight for the determined point in the route to be lower than weights for other points between the location of the user and the destination to revise the route between the location of the user and the destination.

In another embodiment, the processor 920 may obtain user information including at least one of information about route characteristics preferred by the user and information about a condition of the user. The processor 920 may set a weight for at least one route between the user location and the destination based on the user information to determine a final route. In the meantime, the processor 920 may obtain the user information based on information about at least one route selected by the user before determining the final route, by using a pre-generated learning network model.

The processor 920 may periodically receive metadata at preset time intervals from the connectivity node. The processor 920 may predict a dangerous situation in real time that is likely to occur to the user through the periodically received metadata.

Furthermore, the processor 920 may generate guide information to avoid the predicted dangerous situation based on time required for the terminal of the user to receive a notification about the dangerous situation, moving speed of the user, and a time at which the dangerous situation is predicted to occur. The guide information may be transmitted to the terminal of the user through the transceiver 910 in the notification.

The memory 930 may store the route information, the metadata, etc., included in the signal obtained by the base station 900, and have sectors for storing data required to control the processor 920 and data that occurs in the control operation of the processor 920. For example, the memory 930 may store information about the final route determined by the processor 920. Furthermore, the memory 930 may store a database preset for avoidance targets.

The memory 930 may be implemented in various forms, such as read only memory (ROM) and/or random access memory (RAM) and/or hard disk and/or compact disc (CD)-ROM and/or digital versatile disk (DVD), and/or the like.

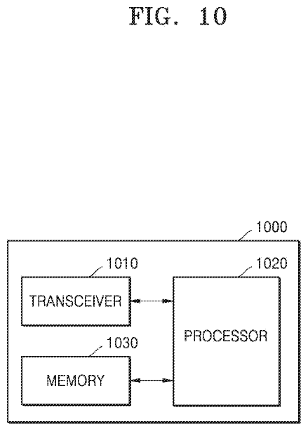

FIG. 10 is a block diagram of a connectivity node 1000, according to an embodiment.

Referring to FIG. 10, the connectivity node 1000 may include a transceiver 1010, a processor 1020, and a memory 1030. According to the method of providing route information by the connectivity node 1000 as proposed in the above embodiments of the disclosure, the transceiver 1010, the processor 1020, and the memory 1030 may operate. Elements of the connectivity node 1000 according to an embodiment are not, however, limited thereto. In another embodiment of the disclosure, the connectivity node 1000 may include more or fewer elements than mentioned above. In addition, in a special occasion, the transceiver 1010, processor 1020, and memory 1030 may be implemented in a single chip.

The transceiver 1010 may transmit or receive signals with at least one of at least one electronic device, a terminal, and a base station. In this case, the signal may include data sensed by the at least one electronic device, metadata, a notification about a dangerous situation, etc., but it is merely an example and is not limited to the aforementioned example. For example, the transceiver 1010 may receive the sensed data about a geographical feature and an object within preset coverage from the at least one electronic device. Furthermore, the transceiver 910 may transmit metadata that represents at least one of a geographical feature and an object generated by the processor 920 to the base station.

The transceiver 1010 may include a short-range wireless communication unit including a Bluetooth communication module, a Bluetooth low energy (BLE) communication module, a near field communication (NFC) module, a wireless local area network (WLAN), e.g., Wi-Fi, communication module, a Zigbee communication module, an infrared data association (IrDA) communication module, a Wi-Fi direct (WFD) communication module, an ultra wideband (UWB) communication module, an Ant+communication module, etc., without being limited thereto. The transceiver 1010 may receive data sensed by the at least one electronic device through the short-range wireless communication unit. It is, however, merely an example, and the transceiver 1010 may communicate with the at least one electronic device through a mobile communication unit, which will be described at a later time.

The transceiver 1010 may also include the mobile communication unit to transmit or receive a signal with a base station over a mobile communication network on a wireless channel.

The processor 1020 may control a series of processes for the connectivity node 1000 to operate in accordance with the embodiments of the present disclosure. For example, the processor 1020 may perform a method of providing route information in the aforementioned embodiments of the disclosure.

In an embodiment, the processor 1020 may generate metadata that represents at least one of a geographical feature and an object by analyzing the data received from the at least one electronic device. For example, the processor 1020 may analyze at least one of type, mobility and density of the object, and inclination of the geographical feature based on the received data.

Furthermore, the processor 1020 may predict a dangerous situation that is likely to occur to the user based on the received data when it is determined based on the location information of the user that the user is located within the preset coverage. The processor 1020 may generate guide information to avoid the predicted dangerous situation based on time required for the terminal of the user to receive a notification about the dangerous situation, moving speed of the user, and a time at which the dangerous situation is predicted to occur. The guide information may be transmitted in the notification about the predicted dangerous situation to the terminal of the user.

The memory 1030 may store data generated by the connectivity node 1000, and have sectors for storing data required to control the processor 1020 and data that occurs in the control operation of the processor 1020. For example, the memory 1030 may store the metadata generated by the processor 1020.

The memory 1030 may be implemented in various forms, such as ROM and/or RAM and/or hard disk and/or CD-ROM and/or DVD, and/or the like.

Several embodiments have been described above, but a person of ordinary skill in the art will understand and appreciate that various modifications can be made without departing the scope of the present disclosure.

Thus, it will be apparent to those ordinary skilled in the art that the disclosure is not limited to the embodiments described, which have been provided only for illustrative purposes. Furthermore, the embodiments of the disclosure are separated for convenience of explanation, but may be operated by being combined with one another if necessary. For example, parts of embodiment 1, embodiment 2, embodiment 3, and embodiment 4 of the disclosure may be combined to operate the base station and the terminal.

A device according to an embodiment may include a processor, a memory for storing program data and executing it, a permanent storage such as a disk drive, a communications port for handling communications with external devices, and user interface devices, including a touch panel, keys, buttons, etc. Methods to be implemented as software modules or algorithms may be stored as program instructions or computer readable codes executable on the processor on a computer-readable medium. Examples of the computer readable recording medium include magnetic storage media (e.g., ROM, floppy disks, hard disks, etc.), and optical recording media (e.g., CD-ROMs, or DVDs). The computer readable recording medium may also be distributed over network coupled computer systems so that the computer readable code is stored and executed in a distributed fashion. This media may be read by the computer, stored in the memory, and executed by the processor.

Embodiments of the disclosure may be described in terms of functional block components and various processing steps. Such functional blocks may be implemented by any number of hardware and/or software components configured to perform the specified functions. For example, embodiments of the disclosure may employ various integrated circuit components, e.g., memory elements, processing elements, logic elements, look-up tables, and the like, which may carry out a variety of functions under the control of one or more microprocessors or other control devices. Similarly, where the elements of the embodiments of the disclosure are implemented using software programming or software elements the disclosure may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors, Furthermore, the embodiments of the disclosure could employ any number of conventional techniques for electronics configuration, signal processing and/or control, data processing and the like.

1. A method of providing route information by a base station, the method comprising:
obtaining information about a route between a location of a user and a destination requested by the user;
receiving metadata representing at least one of a geographical feature and an object within a preset coverage from a connectivity node;
determining a final route to the destination based on the obtained information about the route and the received metadata; and
transmitting information about the determined final route to a terminal of the user.

2. The method of claim 1, wherein the determining of the final route comprises:
comparing the received metadata with a database preset with respect to avoidance targets to determine a point including the avoidance target or a point predicted to have the avoidance target in the route; and
setting a weight for the determined point in the route to be relatively lower than weights for other points between the location of the user and the destination to revise the route between the location of the user and the destination.

3. The method of claim 1, further comprising:
obtaining user information including at least one of information about route characteristics preferred by the user and information about a condition of the user,
wherein the determining of the final route comprises setting a weight for at least one route between the location of the user and the destination based on the user information so as to determine the final route.

4. The method of claim 1, wherein the metadata is periodically received from the connectivity node at preset time intervals, and
wherein the method of providing route information further comprises:
predicting a dangerous situation likely to occur to the user based on the periodically received metadata and a location of the user at a time of receiving the metadata; and
transmitting a notification about the predicted dangerous situation to the terminal of he user.

5. A method of providing route information by a connectivity node, the method comprising:
receiving data about a geographical feature and an object within a preset coverage sensed from at least one electronic device;
generating, by analyzing the received data, metadata representing at least one of the geographical feature and the object; and
transmitting the generated metadata to a base station.

6. The method of claim 5, wherein the generating of the metadata comprises analyzing at least one of a type, mobility, and density of the object, and an inclination of the geographical feature, based on the received data.

7. The method of claim 5, further comprising:
obtaining location information of a user; and
predicting a dangerous situation likely to occur to the user based on the received data when it is determined based on the location information of the user that the user is located within the preset coverage; and
transmitting a notification about the predicted dangerous situation to a terminal of the user.

8. A base station comprising:
a transceiver configured to obtain information about a route between a location of a user and a destination requested by the user, and receive metadata representing at least one of a geographical feature and an object within a preset coverage from a connectivity node;
at least one processor configured to determine a final route to the destination based on the obtained information about the route and the received metadata; and
a memory storing information about the final route,
wherein the transceiver is further configured to transmit the information about the determined final route to a terminal of a user.

9. The base station of claim 8, wherein the at least one processor is further configured to:
compare the received metadata with a database preset with respect to avoidance targets to determine a point including the avoidance target or a point predicted to have the avoidance target in the route, and
set a weight for the determined point in the route to be relatively lower than weights for other points between the location of the user and the destination to revise the route between the location of the user and the destination.

10. The base station of claim 8, wherein the at least one processor is further configured to:
obtain user information including at least one of information about route characteristics preferred by the user and information about a condition of the user, and
set a weight for at least one route between the location of the user and the destination based on the user information so as to determine the final route.

11. The base station of claim 8, wherein the metadata is periodically received from the connectivity node at preset time intervals,
wherein the at least one processor is further configured to predict a dangerous situation likely to occur to the user based on the periodically received metadata and a location of the user at a time of receiving the metadata, and
wherein the transceiver is further configured to transmit a notification about the predicted dangerous situation to the terminal of the user.

12. A connectivity node comprising:
a transceiver configured to receive data about a geographical feature and an object within a preset coverage sensed from at least one electronic device;
at least one processor configured to generate, by analyzing the received data, metadata representing at least one of the geographical feature and the object; and
a memory storing the generated metadata,
wherein the transceiver is further configured to transmit the generated metadata to a base station.

13. The connectivity node of claim 12, wherein the at least one processor is further configured to analyze at least one of a type, mobility, and density of the object, and an inclination of the geographical feature, based on the received data.

14. The connectivity node of claim 12, wherein the at least one processor is further configured to obtain location information of a user and predict a dangerous situation likely to occur to the user based on the received data when it is determined based on the location information of the user that the user is located within the preset coverage, and
wherein the transceiver is further configured to transmit a notification about the predicted dangerous situation to a terminal of the user.

15. A computer-readable recording medium having recorded thereon a program for executing the method of claim 1 on a computer.
